(19) United States
(12) Patent Application Publication
(10) Pub. No.: US 2008/0123220 A1
(43) Pub. Date: May 29, 2008

(54) Head slider and storage medium drive

(75) Inventor: Osamu Kajitani, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/895,601

(22) Filed: Aug. 24, 2007

(30) Foreign Application Priority Data
Nov. 24, 2006 (JP) 2006-317197

(51) Int. Cl. G11B 5/60

(52) U.S. Cl. 360/236.3

(57) ABSTRACT

A first rail is formed on a medium-opposed surface in a head slider. A head element is embedded in the first rail. Second rails are formed on the medium-opposed surface at positions upstream of the head element. Negative pressure generating areas is defined at positions downstream of the second rail. A groove is formed on the medium-opposed surface. The groove isolates the first rail from a specific negative pressure generating area located nearest to the outflow end of the slider body among the negative pressure generating areas. Negative pressure is generated at the negative pressure generating areas behind the second rail. The lubricant spatters from the surface of the storage medium to the negative pressure generating areas. The lubricant moves downstream from the second rail. The lubricant directed to the first rail flows into the groove. The lubricant is prevented from reaching the first rail.

### BACKGROUND OF THE INVENTION

1. Field of the Invention

The present invention relates to a head slider incorporated in a storage medium drive such as a hard disk drive, HDD.

2. Description of the Prior Art

A head slider includes a slider body defining a medium-opposed surface opposed to a hard disk, HD, as disclosed in Japanese Patent Application Publication No. 2004-164771, for example. A front rail is formed on the medium-opposed surface near the inflow end of the slider body. A rear rail is formed on the medium-opposed surface near the outflow end of the slider body. An electromagnetic transducer is embedded in the rear rail. A pair of auxiliary rear rails is formed on the medium-opposed surface at positions upstream of the head element.

Airflow is induced along the rotating hard disk. The airflow flows from the inflow end toward the outflow end of the slider body. Positive pressure is thus generated at air bearing surfaces defined on the top surfaces of the front rail, the rear rail and the auxiliary rear rails. Negative pressure is simultaneously generated at positions downstream of the front rail and the auxiliary rear rails. The balance between the positive pressure and the negative pressure allows the head slider to fly above the hard disk.

A lubricant such as perfluoropolyether is applied to the surface of the hard disk. When negative pressure is generated at positions downstream of the front rail and the auxiliary rear rails, the lubricant spatters from the surface of the hard disk toward the medium-opposed surface based on the negative pressure on the medium-opposed surface. The lubricant adhering to the auxiliary rear rails flows toward the outflow end of the slider body with the assistance of the airflow, for example. The lubricant inevitably reaches the electromagnetic transducer. This results in a deteriorated characteristic of the electromagnetic transducer.

### SUMMARY OF THE INVENTION

It is accordingly an object of the present invention to provide a head slider and a storage medium drive, capable of reliably preventing adhesion of a lubricant to a head element.

According to a first aspect of the present invention, there is provided a head slider comprising: a slider body defining a medium-opposed surface opposed to a storage medium; a first rail formed on the medium-opposed surface; a head element embedded in the first rail; at least one second rail formed on the medium-opposed surface at a position upstream of the head element; negative pressure generating areas defined at positions downstream of the second rail, the negative pressure generating areas allowing generation of negative pressure behind the second rail; and a groove formed on the medium-opposed surface, the groove isolating the first rail from a specific negative pressure generating area, the specific negative pressure generating area located nearest to the outflow end of the slider body among the negative pressure generating areas.

The medium-opposed surface is designed to receive airflow in response to relative movement between the head slider and the storage medium. Negative pressure is generated at the negative pressure generating areas behind the second rail. The lubricant spatters from the surface of the storage medium to the negative pressure generating areas. The lubricant spattering toward the negative pressure generating area moves downstream from the second rail. Since the groove isolates the first rail from the negative pressure generating areas, the lubricant directed to the first rail flows into the groove. The lubricant is prevented from reaching the first rail. This results in prevention of adhesion of the lubricant to the head element. The head element is prevented from deterioration in the characteristics.

The groove may reach the outflow end of the slider body in the head slider. The lubricant is allowed to flow along the groove, so that the lubricant is discharged behind the head slider from the outflow end of the slider body. Here, the groove and the outflow end of the slider body in combination may surround the first rail without any break. The lubricant directed to the first rail is thus reliably caught in the groove. The lubricant is prevented from reaching the first rail. This results in prevention of adhesion of the lubricant to the head element.

The groove may extend along the periphery of the second rail, the periphery opposed to the first rail. The lubricant flows along the periphery of the second rail on the medium-opposed surface. If the groove extends along the periphery of the second rail, the lubricant is directly caught in the groove. The lubricant is prevented from reaching the first rail. This results in prevention of adhesion of the lubricant of the head element.

The head slider is incorporated in a storage medium drive. In this case, the storage medium drive may comprise: an enclosure; a head slider enclosed in the enclosure; a slider body defining a medium-opposed surface opposed to a storage medium in the head slider; a first rail formed on the medium-opposed surface; a head element embedded in the first rail; at least one second rail formed on the medium-opposed surface at a position upstream of the head element; negative pressure generating areas defined at positions downstream of the second rail, the negative pressure generating areas allowing generation of negative pressure behind the second rail; and a groove formed on the medium-opposed surface, the groove isolating the first rail from a specific negative pressure generating area, the specific negative pressure generating area located nearest to the outflow end of the slider body among the negative pressure generating areas.

According to a second aspect of the present invention, a head slider comprising: a slider body defining a medium-opposed surface opposed to a storage medium; a first rail group including a first rail or rails formed on the medium-opposed surface, the first rail or rails holding a head element or elements, respectively; a second rail group including a second rail or rails formed on the medium-opposed surface, the second rail or rails distinguished from the first rail or rails; and a groove formed on the medium-opposed surface, the groove isolating the first rail group from the second rail group on the medium-opposed surface.

The medium-opposed surface is designed to receive airflow in response to relative movement between the head slider and the storage medium. Negative pressure is generated behind the rail or rails of the second rail group, namely the second rail or rails. The lubricant spatters from the surface of the storage medium toward a space behind the second rail or rails. The lubricant spattering toward the space behind the second rail or rails moves downstream from the second rail or rails. Since the groove isolates the first rail group from the second rail group, the lubricant directed to the first rail group flows into the groove. The lubricant is prevented from reaching the first rail or rails belonging to the first rail group. This results in prevention of adhesion of the lubricant to the head element. The head element is prevented from deterioration in the characteristics.

The groove may reach the outflow end of the slider body in the head slider. The lubricant is allowed to flow along the groove, so that the lubricant is discharged behind the head slider from the outflow end of the slider body. Here, the groove and the outflow end of the slider body in combination may surround the first rail group without any break. The lubricant directed to the first rail group is thus reliably caught in the groove. The lubricant is prevented from reaching the first rail or rails belonging to the first rail group. This results in prevention of adhesion of the lubricant to the head element.

The groove may extend along the periphery of the second rail, the periphery opposed to rail or rails of the first rail group, namely the first rail or rails. The lubricant flows along the periphery of the second rail on the medium-opposed surface. If the groove extends along the periphery of the second rail, the lubricant is directly caught in the groove. The lubricant is prevented from reaching the first rail or rails. This results in prevention of adhesion of the lubricant of the head element.

The head slider may be incorporated in a storage medium drive. In this case, the storage medium drive may comprise: an enclosure; a head slider enclosed in the enclosure; a slider body defining a medium-opposed surface opposed to a storage medium in the head slider; a first rail group including a first rail or rails formed on the medium-opposed surface, the first rail or rails holding a head element or elements, respectively; a second rail group including a second rail or rails formed on the medium-opposed surface, the second rail or rails distinguished from the first rail or rails; and a groove formed on the medium-opposed surface, the groove isolating the first rail group from the second rail group on the medium-opposed surface.

According to a third aspect of the present invention, there is provided a head slider comprising: a slider body defining a medium-opposed surface opposed to a storage medium; a front rail formed on the medium-opposed surface at a position near the inflow end of the slider body; a rear rail formed on the medium-opposed surface at a position near the outflow end of the slider body; a head element embedded in the rear rail; and a groove formed on the medium-opposed surface, the groove extending from the outflow end of the front rail toward side edges of the slider body, the side edges of the slider body defining the edges of the medium-opposed surface in the longitudinal direction of the slider body.

The medium-opposed surface is designed to receive airflow in response to relative movement between the head slider and the storage medium. Negative pressure is generated behind the front rail. The lubricant spatters from the surface of the storage medium to a space behind the front rail. The lubricant spattering toward the space behind the front rail moves downstream from the front rail. Since the groove extends from the outflow end of the front rail toward the side edges of the slider body, the lubricant directed to the rear rail flows into the groove. The lubricant is discharged from the side edges of the slider body. The lubricant is prevented from reaching the rear rail. This results in prevention of adhesion of the lubricant to the head element. The head element is prevented from deterioration in the characteristics.

The head slider may be incorporated in a storage medium drive. In this case, the storage medium drive may comprise: an enclosure; a head slider enclosed in the enclosure; a slider body defining a medium-opposed surface opposed to a storage medium in the head slider; a front rail formed on the medium-opposed surface at a position near the inflow end of the slider body; a rear rail formed on the medium-opposed surface at a position near the outflow end of the slider body; a head element embedded in the rear rail; and a groove formed on the medium-opposed surface, the groove extending from the outflow end of the front rail toward side edges of the slider body, the side edges of the slider body defining the edges of the medium-opposed surface in the longitudinal direction of the slider body.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive, HDD, as an example of a storage medium drive according to the present invention;

FIG. 2 is a perspective view schematically illustrating a head slider according to a first embodiment of the present invention;

FIG. 3 is a plan view schematically illustrating the head slider;

FIG. 4 is a plan view schematically illustrating a head slider according to a second embodiment of the present invention; and

FIG. 5 is a plan view schematically illustrating a head slider according to a third embodiment of the present invention.

### DESCRIPTION OF THE PREFERRED EMBODIMENTS

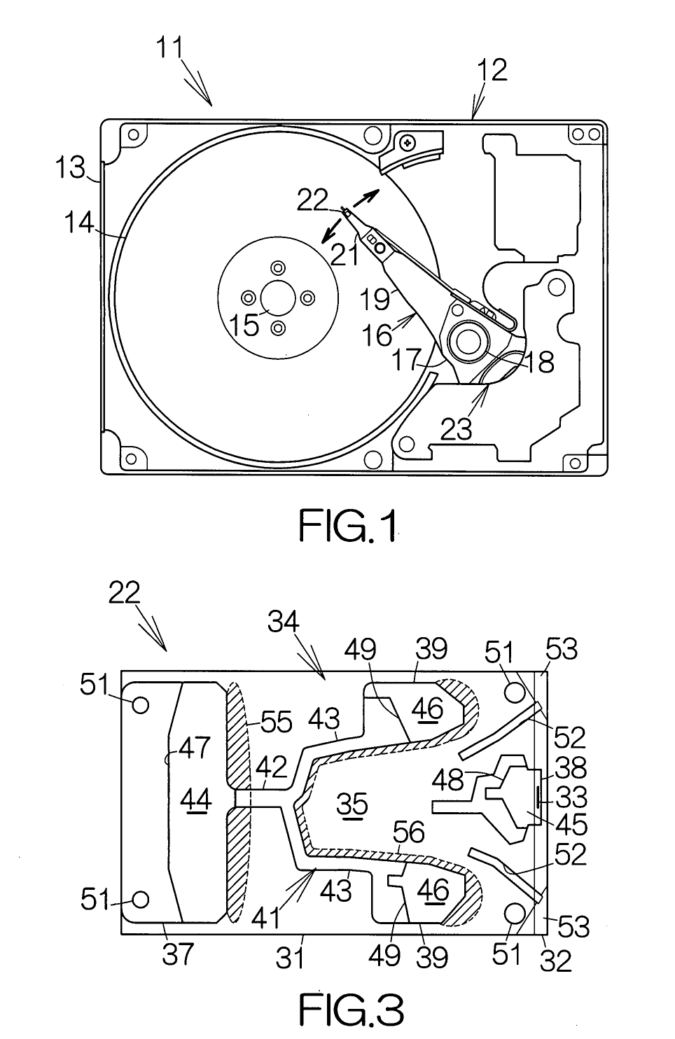

FIG. 1 schematically illustrates the structure of a hard disk drive, HDD, 11 as an example of a storage medium drive or a storage device according to the present invention. The hard disk drive 11 includes an enclosure 12. The enclosure 12 includes a boxed-shaped base 13 and a cover, not shown. The base 13 defines an inner space of a flat parallelepiped, for example. The base 13 may be made of a metallic material such as aluminum, for example. Molding process may be employed to form the base 13. The cover is coupled to the base 13. The cover serves to close the opening of the inner space within the base 13. Pressing process may be employed to form the cover out of a plate material, for example.

At least one magnetic recording disk 14 as a recording medium is placed within the inner space of the base 13. The magnetic recording disk or disks 14 is mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like. A lubricant such as perfluoropolyether is applied to the surface of the individual magnetic recording disk 14.

A carriage 16 is also placed within the inner space of the base 13. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process may be employed to form the carriage block 17, for example.

A head suspension 21 is attached to the front end of the individual carriage arm 19. The head suspension 21 is designed to extend forward from the corresponding front end of the carriage arm 19. A flexure is bonded to the front end of the head suspension 21. The flexure will be described later in detail. A so-called gimbal spring is defined in the flexure. The gimbal spring allows the flying head slider 22 to change its attitude relative to the head suspension 21. An electromagnetic transducer is mounted on the flying head slider 22 as described later in detail.

When the magnetic recording disk 14 rotates, the flying head slider 22 is allowed to receive airflow generated along the rotating magnetic recording disk 14. The airflow serves to generate positive pressure or a lift and negative pressure on the flying head slider 22. The lift and the negative pressure in combination are balanced with the urging force of the head suspension 21. This balance allows the flying head slider 22 to keep flying above the surface of the magnetic recording disk 14 during the rotation of the magnetic recording disk 14 at a higher stability.

When the carriage 16 is driven to swing around the vertical support shaft 18 during the flight of the flying head slider 22, the flying head slider 22 is allowed to move along the radial direction of the magnetic recording disk 14. This radial movement allows the electromagnetic transducer on the flying head slider 22 to cross the data zone between the innermost recording track and the outermost recording track. The electromagnetic transducer on the flying head slider 22 can thus be positioned right above a target recording track on the magnetic recording disk 14.

A power source 23 such as a voice coil motor, VCM, is coupled to the carriage block 17. The power source 23 allows the carriage block 17 to rotate around the vertical support shaft 18. The rotation of the carriage block 17 realizes the swinging movement of the carriage arms 19 and the head suspensions 21.

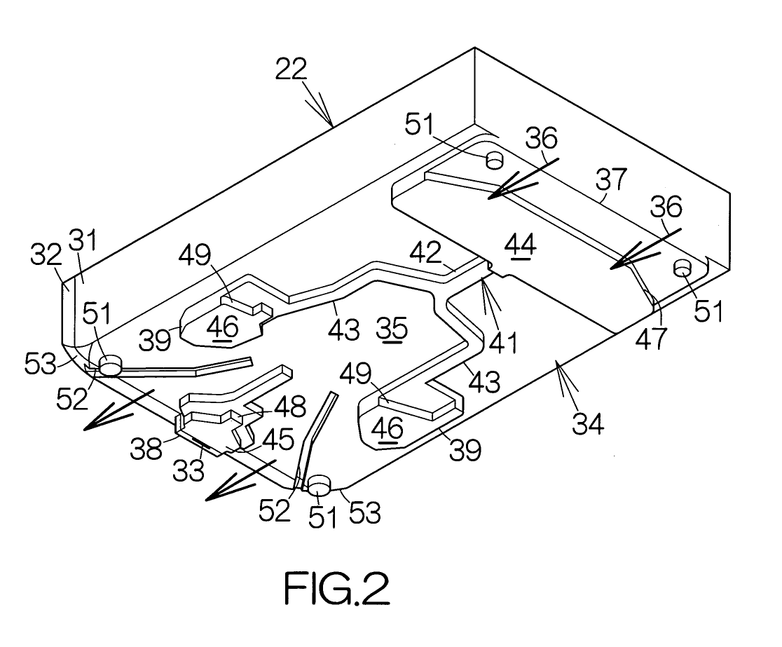

FIG. 2 illustrates a specific example of the flying head slider 22 according to a first embodiment of the present invention. The flying head slider 22 includes a slider body 31 in the form of a flat parallelepiped, for example. A head protection film 32 is overlaid on the outflow or trailing end surface of the slider body 31. The aforementioned electromagnetic transducer 33 is incorporated in the head protection film 32.

The slider body 31 may be made of a hard non-magnetic material such as Al₂O₃—TiC. The head protection film 32 is made of a relatively soft non-magnetic insulating material such as Al₂O₃ (alumina). A medium-opposed surface or bottom surface 34 is defined over the slider body 31 so as to face the magnetic recording disk 14 at a distance. A flat base surface 35 as a reference surface is defined on the bottom surface 34. When the magnetic recording disk 14 rotates, airflow 36 flows along the bottom surface 34 from the inflow or front end toward the outflow or rear end of the slider body 31.

A front rail 37 is formed on the bottom surface 34 of the slider body 31. The front rail 37 stands upright from the base surface 35 of the bottom surface 34 near the inflow end of the slider body 31. The front rail 37 is designed to extend along the inflow end of the base surface 35 in the lateral direction of the slider body 31. A rear rail 38 is likewise formed on the bottom surface 34 of the slider body 31. The rear rail 38 stands upright from the base surface 35 of the bottom surface 34 near the outflow end of the slider body 31. The rear rail 38 is located at the intermediate position in the lateral direction of the slider body 31.

A pair of auxiliary rear rails 39, 39 is likewise formed on the bottom surface 34 of the slider body 31. The auxiliary rear rails 39, 39 stand upright from the base surface 35 of the bottom surface 34 at a position upstream of the electromagnetic transducer 33. The auxiliary rear rails 39, 39 are located along the side edges of the base surface 35, respectively. The side edges serve to contour the base surface 35 in the longitudinal direction of the slider body 31. The auxiliary rear rails 39, 39 are thus distanced from each other in the lateral direction of the slider body 31. The rear rail 38 is located in a space between the auxiliary rear rails 39, 39.

A center rail 41 stands upright from the base surface 35 of the bottom surface 34. The center rail 41 is connected to the outflow end of the front rail 37. The center rail 41 includes a first center rail 42 extending downstream from the outflow end of the front rail 37, and a pair of second center rails 43, 43 bifurcated from the outflow end of the first center rail 42. The second center rails 43 are connected to the inflow ends of the auxiliary rear rails 39, respectively. The second center rails 43 are designed to extend in the lateral direction of the slider body 31 from the outflow end of the first center rail 42. The second center rails 43 then bend to extend in the longitudinal direction of the slider body 31.

It should be noted that the rear rail 38 serves as a first rail and belongs to a first rail group according to the present invention. The front rail 37, the auxiliary rear rails 39 and the center rail 41 serve as a second rail and belongs to a second rail group according to the present invention.

Air bearing surfaces 44, 45, 46, 46 are defined on the top surfaces of the front rail 37, the rear rail 38, the auxiliary rear rails 39, 39, respectively. Steps 47, 48, 49 are defined at the inflow ends of the air bearing surfaces 44, 45, 46, respectively. The steps 47, 48, 49 connect the air bearing surfaces 44, 45, 46 to the top surfaces of the rails 37, 38, 39, respectively. The bottom surface 34 of the flying head slider 22 is designed to receive the airflow 36 generated along the rotating magnetic recording disk 14. The steps 47, 48, 49 serve to generate a larger positive pressure or lift at the air bearing surfaces 44, 45, 46, respectively.

Pads 51 are formed on the top surface of the front rail 37 and the base surface 35 of the bottom surface 34 at positions distanced from the air bearing surfaces 44, 45, 46. One pair of pads 51, 51 is formed near the inflow end of the slider body 31. The tip ends of the pads 51, 51 in this one pair are defined in an imaginary plane extending in parallel with the base surface 35 at a level equal to the level of the air bearing surfaces 44, 45, 46 from the base surface 35. The other pair of pads 51, 51 is formed near the outflow end of the slider body 31. The tip ends of the pads 51, 51 in the other pair are defined in an imaginary plane extending in parallel with the base surface 35 at a level lower than the level of the air bearing surfaces 44, 45, 46 from the base surface 35. The flying head slider 22 is thus forced to contact with the surface of the magnetic recording disk 14 at the pad or pads 51 even if the flying head slider 21 takes any flying attitude. This results in prevention of damage to the flying head slider 22.

A pair of grooves 52, 52 is formed on the base surface 35 at positions between the rear rail 38 and the auxiliary rear rails 39, respectively, for example, in the flying head slider 22. The inflow ends of the grooves 52 are defined at positions upstream of the inflow end of the air bearing surface 45. The grooves 52 are designed to reach the outflow end of the base surface 35. The outflow ends of the grooves 52 are defined in chamfered or curved surfaces 53, respectively, at the corners of the outflow end of the base surface 35. The curved surfaces 53 are connected to the side surfaces and the outflow end surface of the flying head slider 22.

Here, the difference of altitude or elevation is set in a range from 0.8 μm to 2.0 μm approximately between the base surface 35 and an imaginary plane including the air bearing surfaces 44, 45, 46, for example. The difference of altitude is set in of the grooves 52 and the imaginary plane including the air bearing surfaces 44, 45, 46, for example. The difference of altitude is set in a range from 0.07 μm to 0.30 μm between the top surface of the front rail 37 outside the air bearing surface 44 and the imaginary plane including the air bearing surfaces 44, 45, 46, between the top surface of the rear rail 38 outside the air bearing surface 45 and the imaginary plane including the air bearing surfaces 44, 45, 46, between the top surface of the auxiliary rear rail 39 outside the air bearing surface 46 and the imaginary plane including the air bearing surfaces 44, 45, 46, and between the top surfaces of the center rail 41 and the imaginary plane including the air bearing surfaces 44, 45, 46, for example.

As shown in FIG. 3, a negative pressure generating area 55 is defined at a position downstream of the front rail 37 in the flying head slider 22. A negative pressure generating area 56 is likewise defined at a position downstream of the auxiliary rear rails 39. The negative pressure generating area 56 is designed to extend upstream from the outflow ends of the auxiliary rear rails 39 along the side surfaces or inward surfaces of the second center rails 43. The negative pressure generating areas 55, 56 allow generation of negative pressure behind the front rail 37, the second center rails 43 and the auxiliary rear rails 39. The negative pressure is balanced with the lift for establishment of a predetermined flying attitude of the flying head slider 22.

The aforementioned grooves 52 are designed to isolate the rear rail 38 from the front rail 37, the auxiliary rear rails 39 and the center rail 41. Here, the grooves 52 serve to isolate the rear rail 38 at least from the negative pressure generating area 56 closest to the outflow end of the slider body 31.

A protection film, not shown, is formed on the surface of the slider body 31 at the air bearing surfaces 44, 45, 46, for example. The electromagnetic transducer 33 includes a read gap and a write gap. The read gap and write gap are exposed on the surface of the head protection film 32 at positions downstream of the air bearing surface 45. The protection film covers over the read gap and the write gap. The protection film may be made of diamond-like-carbon (DLC), for example. It should be noted that the flying head slider 22 may take any shape or form different from the described one.

When the flying head slider 22 flies during the rotation of the magnetic recording disk 14, for example, negative pressure is generated at the negative pressure generating areas 55, 56. The lubricant spatters from the surface of the magnetic recording disk 14 to the negative pressure generating areas 55, 56. The lubricant spattering toward the negative pressure generating area 55 stays along the outflow end or periphery of the front rail 37. The lubricant moves downstream along the side surfaces or outward surfaces of the center rail 41 and the auxiliary rear rails 39. The lubricant spattering toward the negative pressure generating area 56 stays along the side surfaces or inward surfaces of the second center rails 43 and the auxiliary rear rails 39. The lubricant moves downstream on the base surface 35 along the inward surfaces of the second center rails 43 and the auxiliary rear rails 39.

The flying head slider 22 allows the grooves 52 to isolate the rear rail 38 from the negative pressure generating areas 55, 56. The lubricant thus flows into the grooves 52 along the inward and outward surfaces of the auxiliary rear rails 39 in response to establishment of a predetermined skew angle in the flying head slider 22. The grooves 52 in this manner function as flow passages of the lubricant. The lubricant is discharged behind the flying head slider 22 from the outflow end of the base surface 35. The grooves 52 thus prevent the lubricant from flowing toward the rear rail 38. The lubricant is prevented from reaching the rear rail 38. This results in prevention of adhesion of the lubricant to the electromagnetic transducer 33. The electromagnetic transducer 33 is thus prevented from deterioration in the characteristics.

A method of making the aforementioned flying head slider 22 comprises cutting a wafer bar out of a wafer. The cut surface of the wafer bar is subjected to etching process, for example. This results in formation of the pads 51, the front rail 37, the rear rail 38, the auxiliary rear rails 39, 39 and the center rail 41. The bottom surface 34 is in this manner formed. A resist film is formed on the bottom surface 34 except areas of the grooves 52. The bottom surface 34 is subjected to etching process outside the resist film. This results in establishment of the grooves 52. The flying head slider 22 is then cut out from the wafer bar.

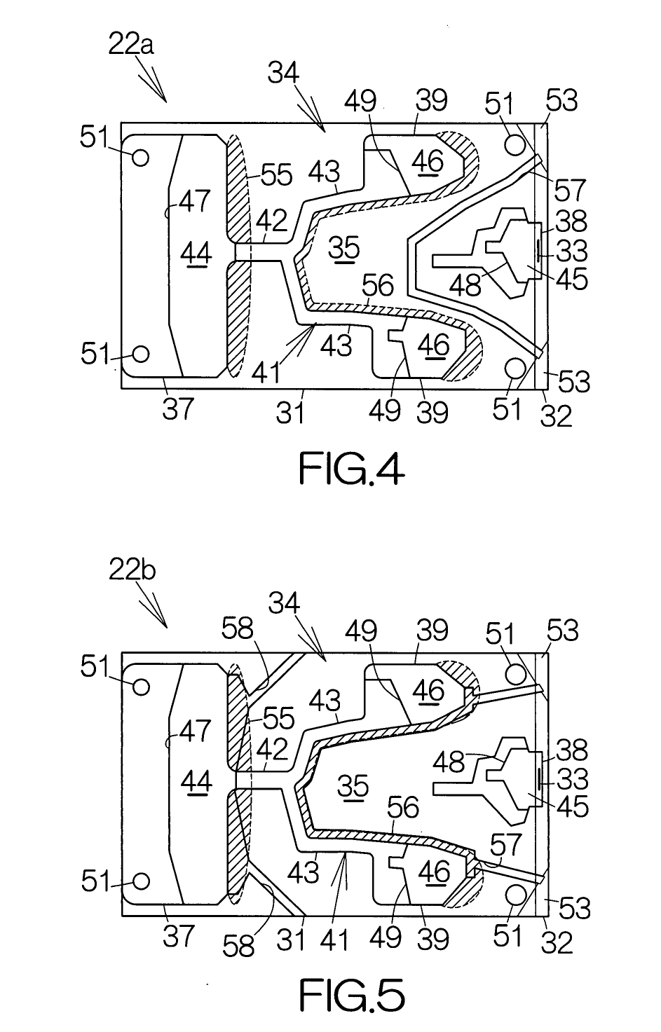

As shown in FIG. 4, a flying head slider 22a according to a second embodiment may be incorporated in the hard disk drive 11 in place of the flying head slider 22. The flying head slider 22a allows establishment of a single groove 57 on the base surface 35 at a position between the rear rail 38 and the auxiliary rear rails 39, for example. The opposite ends of the groove 57 are defined in the curved surfaces 53, respectively. The groove 57 and the outflow end of the base surface 35 in combination surround the rear rail 38 without any break. The groove 57 serves to isolate the rear rail 38 from the negative pressure generating areas 55, 56. The difference of altitude is set in a range from 2.5 μn to 5.0 μn approximately between the bottom of the groove 57 and the imaginary plane including the air bearing surfaces 44, 45, 46 in the same manner as described above. Like reference numerals are attached to the structure or components equivalent to those of the aforementioned flying head slider 22.

The flying head slider 22a allows generation of negative pressure at the negative pressure generating areas 55, 56 in the same manner as described above. The lubricant spatters from the surface of the magnetic recording disk 14 toward the negative pressure generating areas 55, 56. Since the groove 57 serves to isolate the rear rail 38 from the negative pressure generating areas 55, 56, the lubricant spattering to the negative pressure generating areas 55, 56 is thus forced to flow into the groove 57. The groove 57 thus functions as a flow passage of the lubricant. The lubricant is discharged behind the flying head slider 22a from the outflow end of the base surface 35. The lubricant is prevented from reaching the rear rail 38. This results in prevention of adhesion of the lubricant to the electromagnetic transducer 33. The electromagnetic transducer 33 is thus prevented from deterioration in the characteristics.

As shown in FIG. 5, a flying head slider 22b according to a third embodiment may be incorporated in the hard disk drive 11 in place of the flying head sliders 22, 22a. The aforementioned groove 57 is designed to extend between the outflow ends of the auxiliary rear rails 39 along the inward surfaces of the second center rails 43 and the inward surfaces of the auxiliary rear rails 39. These inward surfaces are opposed to the inflow end of the rear rail 38. The groove 57 thus lies over the negative pressure generating area 56. The ends of the groove 57 are respectively defined in the curved surfaces 53 in the same manner as descried above. The groove 57 serves to isolate the rear rail 38 from the negative pressure generating areas 55, 56 in this manner.

A pair of grooves 58, 58 is also formed on the base surface 35. The grooves 58, 58 are designed to extend from the outflow end of the front rail 37. The inflow ends of the grooves 58 are designed to extend over the entire length of the outflow end of the front rail 37. The grooves 58 thus lie over the negative pressure generating area 55. The outflow ends of the grooves 58 reach the side edges of the base surface 35, respectively. The difference of altitude is set in a range from 0.5 μm to 3.0 μm approximately between the bottoms of the grooves 58 and the base surface 35, for example. Like reference numerals are attached to the structure or components equivalent to those of the aforementioned flying head slider 22a.

The flying head slier 22b allows generation of negative pressure at the negative pressure generating area 55. The lubricant spatters from the surface of the magnetic recording disk 14 to the negative pressure generating area 55. Since the grooves 58 covers the negative pressure generating area 55, the lubricant spattering to the negative pressure generating area 55 is caught in the grooves 58. The lubricant is in this manner stored in the grooves 58. The grooves 58 thus function as flow passages of the lubricant. The lubricant is discharged out of the flying head slider 22b from the side edges of the base surface 35. The lubricant is prevented from reaching the rear rail 38. This results in prevention of adhesion of the lubricant to the electromagnetic transducer 33. The electromagnetic transducer 33 is thus prevented from deterioration in the characteristics.

Negative pressure is likewise generated at the negative pressure generating area 56 in the flying head slider 22b. The lubricant thus spatters from the surface of the magnetic recording disk 14 to the negative pressure generating area 56. Since the groove 57 covers the negative pressure generating area 56, the lubricant spattering to the negative pressure generating area 56 is caught in the groove 57. The lubricant is in this manner stored in the groove 57. The groove 57 thus functions as a flow passage of the lubricant. The lubricant is discharged behind the flying head slider 22b from the outflow end of the base surface 35 in the same manner as described above. The lubricant is prevented from reaching the rear rail 38. This results in prevention of adhesion of the lubricant to the electromagnetic transducer 33. The electromagnetic transducer 33 is thus prevented from deterioration in the characteristics.

What is claimed is:

1. A head slider comprising:
a slider body defining a medium-opposed surface opposed to a storage medium;
a first rail formed on the medium-opposed surface;
a head element embedded in the first rail;
at least one second rail formed on the medium-opposed surface at a position upstream of the head element;
negative pressure generating areas defined at positions downstream of the second rail, the negative pressure generating areas allowing generation of negative pressure behind the second rail; and
a groove formed on the medium-opposed surface, the groove isolating the first rail from a specific negative pressure generating area, the specific negative pressure generating area located nearest to an outflow end of the slider body among the negative pressure generating areas.

2. The head slider according to claim 1, wherein the groove reaches the outflow end of the slider body.

3. The head slider according to claim 2, wherein the groove and the outflow end of the slider body in combination surrounds the first rail without any break.

4. The head slider according to claim 1, wherein the groove extends along a periphery of the second rail, the periphery opposed to the first rail.

5. A head slider comprising:
a slider body defining a medium-opposed surface opposed to a storage medium;
a first rail group including a first rail or rails formed on the medium-opposed surface, the first rail or rails holding a head element or elements, respectively;
a second rail group including a second rail or rails formed on the medium-opposed surface, the second rail or rails distinguished from the first rail or rails; and
a groove formed on the medium-opposed surface, the groove isolating the first rail group from the second rail group on the medium-opposed surface.

6. The head slider according to claim 5, wherein the groove reaches an outflow end of the slider body.

7. The head slider according to claim 6, wherein the groove and the outflow end of the slider body in combination surrounds the first rail group without any break.

8. The head slider according to claim 5, wherein the groove extends along a periphery or peripheries of the second rail or rails, the periphery or peripheries opposed to the first rail.

9. A head slider comprising:
a slider body defining a medium-opposed surface opposed to a storage medium;
a front rail formed on the medium-opposed surface at a position near an inflow end of the slider body;
a rear rail formed on the medium-opposed surface at a position near an outflow end of the slider body;
a head element embedded in the rear rail; and
a groove formed on the medium-opposed surface, the groove extending from an outflow end of the front rail toward side edges of the slider body, the side edges of the slider body defining edges of the medium-opposed surface in a longitudinal direction of the slider body.

10. A storage medium drive comprising:
an enclosure;
a head slider enclosed in the enclosure;
a slider body defining a medium-opposed surface opposed to a storage medium in the head slider;
a first rail formed on the medium-opposed surface;
a head element embedded in the first rail;
at least one second rail formed on the medium-opposed surface at a position upstream of the head element;
negative pressure generating areas defined at positions downstream of the second rail, the negative pressure generating areas allowing generation of negative pressure behind the second rail; and
a groove formed on the medium-opposed surface, the groove isolating the first rail from a specific negative pressure generating area, the specific negative pressure generating area located nearest to an outflow end of the slider body among the negative pressure generating areas.

11. The storage medium drive according to claim 10, wherein the groove reaches the outflow end of the slider body.

12. The storage medium drive according to claim 11, wherein the groove and the outflow end of the slider body in combination surrounds the first rail without any break.

13. The storage medium drive according to claim 10, wherein the groove extends along a periphery of the second rail, the periphery opposed to the first rail.

14. A storage medium drive comprising:
an enclosure;
a head slider enclosed in the enclosure;
a slider body defining a medium-opposed surface opposed to a storage medium in the head slider;
a first rail group including a first rail or rails formed on the medium-opposed surface, the first rail or rails holding a head element or elements, respectively;
a second rail group including a second rail or rails formed on the medium-opposed surface, the second rail or rails distinguished from the first rail or rails; and
a groove formed on the medium-opposed surface, the groove isolating the first rail group from the second rail group on the medium-opposed surface.

15. The storage medium drive according to claim 14, wherein the groove reaches an outflow end of the slider body.

16. The storage medium drive according to claim 15, wherein the groove and the outflow end of the slider body in combination surrounds the first rail group without any break.

17. The storage medium drive according to claim 14, wherein the groove extends along a periphery or peripheries of the second rail or rails, the periphery or peripheries opposed to the first rail.

18. A storage medium drive comprising:
an enclosure;
a head slider enclosed in the enclosure;
a slider body defining a medium-opposed surface opposed to a storage medium in the head slider;
a front rail formed on the medium-opposed surface at a position near an inflow end of the slider body;
a rear rail formed on the medium-opposed surface at a position near an outflow end of the slider body;
a head element embedded in the rear rail; and
a groove formed on the medium-opposed surface, the groove extending from an outflow end of the front rail toward side edges of the slider body, the side edges of the slider body defining edges of the medium-opposed surface in a longitudinal direction of the slider body.
